(19) United States
(12) Patent Application Publication
(10) Pub. No.: US 2020/0137515 A1
(43) Pub. Date: Apr. 30, 2020

(54) FACILITATING PROXIMITY BASED CONNECTIONS AT AN EVENT

(71) Applicant: INTERNATIONAL BUSINESS MACHINES CORPORATION, Armonk, NY (US)

(72) Inventors: YUK L. CHAN, ROCHESTER, NY (US); HEIDI LAGARES-GREENBLATT, JEFFERSON HILLS, PA (US); JENNY S. LI, CARY, NC (US); DEEPTI M. NAPHADE, CUPERTINO, CA (US)

(21) Appl. No.: 16/174,608

(22) Filed: Oct. 30, 2018

(51) Int. Cl. H04W 4/02; G06F 17/30; H04W 76/14

(52) U.S. Cl. CPC H04W 4/023; H04W 76/14; G06F 17/30876

(57) ABSTRACT

Examples of techniques for facilitating proximity based connections at an event are disclosed. Aspects include obtaining registration information for an attendee at the event, the registration information including personal information of the attendee, an identification number of the attendee, and an event goal for the attendee. Aspects also include instructing a mobile device of the attendee to broadcast the identification number of the attendee. Aspects further include receiving, from the mobile device of the attendee, identification numbers of other attendees at the event in proximity to the attendee and obtaining personal information of the other attendees based on the identification numbers. Aspects also include alerting the attendee to connect with one of the one of the other attendees based at least in part on an overlap of the event goal for the attendee and the personal information of the one of the other attendees.

### BACKGROUND

The present invention generally relates to connecting individuals, and more specifically, to facilitating proximity based connections at an event.

Often today, people use peer-to-peer and social networking technology to connect with each other. While peer-to-peer and social networking technology has made connecting with individuals you know easier, there remain difficulties in connecting with people around you that you don't already know. Current solutions require individuals to share personal information with everyone around them in order for the other individuals to connect with them.

### SUMMARY

Embodiments of the present invention are directed to a computer-implemented method for facilitating proximity based connections at an event. An example of the computer-implemented method includes obtaining registration information for an attendee at an event, the registration information including personal information of the attendee, an identification number of the attendee, and an event goal for the attendee. The method also includes instructing a mobile device of the attendee to broadcast the identification number of the attendee based on a determination that the attendee is at the event. The method further includes receiving, from the mobile device of the attendee, one or more identification numbers of other attendees at the event in proximity to the attendee and obtaining personal information of the other attendees based on the one or more identification numbers. The method also includes alerting the attendee to connect with one of the one of the other attendees based at least in part on an overlap of the event goal for the attendee and the personal information of the one of the other attendees.

Embodiments of the present invention are directed to a computer program product for protecting sensitive information stored on audio recordings. The computer program product being on a computer readable storage medium having program instructions embodied therewith, the program instructions executable by a processing device to cause the processing device to perform a method. The method includes obtaining registration information for an attendee at an event, the registration information including personal information of the attendee, an identification number of the attendee, and an event goal for the attendee. The method also includes instructing a mobile device of the attendee to broadcast the identification number of the attendee based on a determination that the attendee is at the event. The method further includes receiving, from the mobile device of the attendee, one or more identification numbers of other attendees at the event in proximity to the attendee and obtaining personal information of the other attendees based on the one or more identification numbers. The method also includes alerting the attendee to connect with one of the one of the other attendees based at least in part on an overlap of the event goal for the attendee and the personal information of the one of the other attendees.

Embodiments of the present invention are directed to a system for facilitating proximity based connections at an event. The system includes a memory having computer readable instructions and a processing device for executing the computer readable instructions for performing a method. The method includes obtaining registration information for an attendee at an event, the registration information including personal information of the attendee, an identification number of the attendee, and an event goal for the attendee. The method also includes instructing a mobile device of the attendee to broadcast the identification number of the attendee based on a determination that the attendee is at the event. The method further includes receiving, from the mobile device of the attendee, one or more identification numbers of other attendees at the event in proximity to the attendee and obtaining personal information of the other attendees based on the one or more identification numbers. The method also includes alerting the attendee to connect with one of the one of the other attendees based at least in part on an overlap of the event goal for the attendee and the personal information of the one of the other attendees.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments described herein;

FIG. 2 depicts abstraction model layers according to one or more embodiments described herein;

FIG. 3 depicts a block diagram of a processing system for implementing the described techniques according to one or more embodiments described herein;

FIG. 4 depicts a block diagram of a system for facilitating proximity based connections at an event according to one or more embodiments described herein;

FIG. 5 depicts a flow diagram of a method for facilitating proximity based connections at an event according to one or more embodiments described herein;

FIG. 6 depicts a flow diagram of a method for facilitating proximity based connections at an event according to one or more embodiments described herein; and

FIG. 7 depicts a flow diagram of a method for facilitating proximity based connections at an event according to one or more embodiments described herein; and

FIG. 8 depicts a flow diagram of a method for facilitating proximity based connections at an event according to one or more embodiments described herein.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

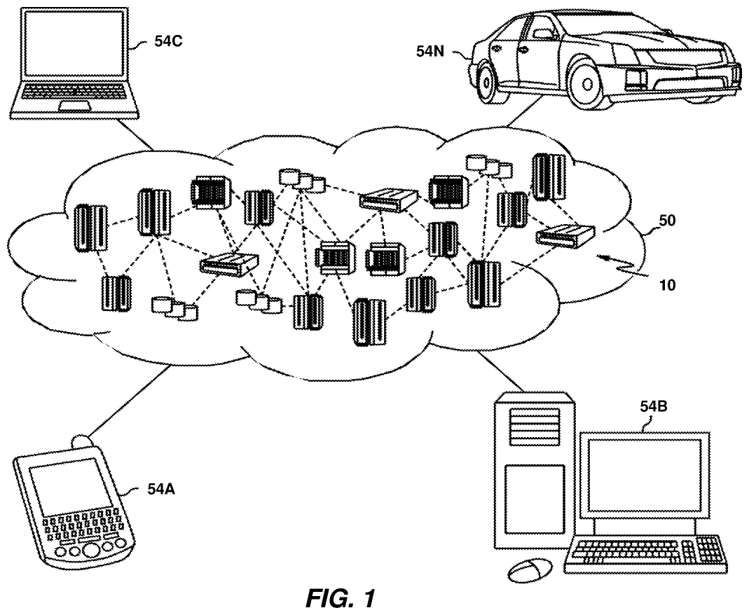

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

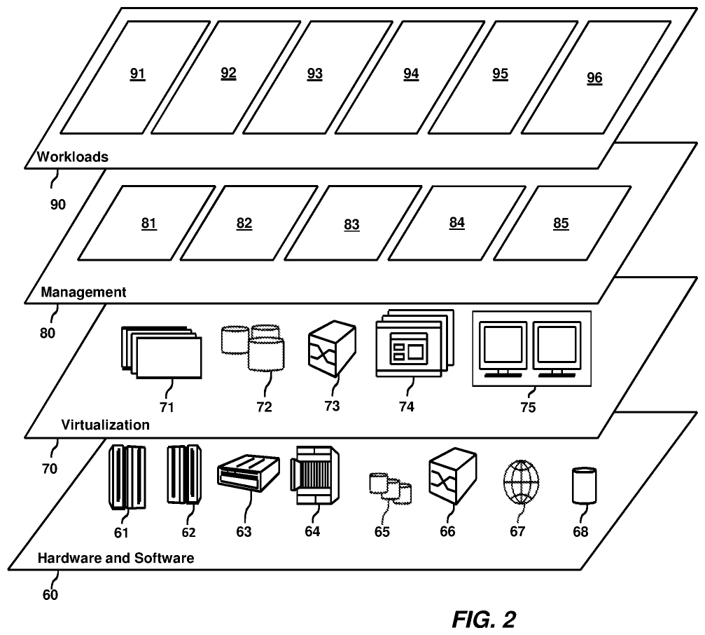

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and facilitating proximity based connections 96.

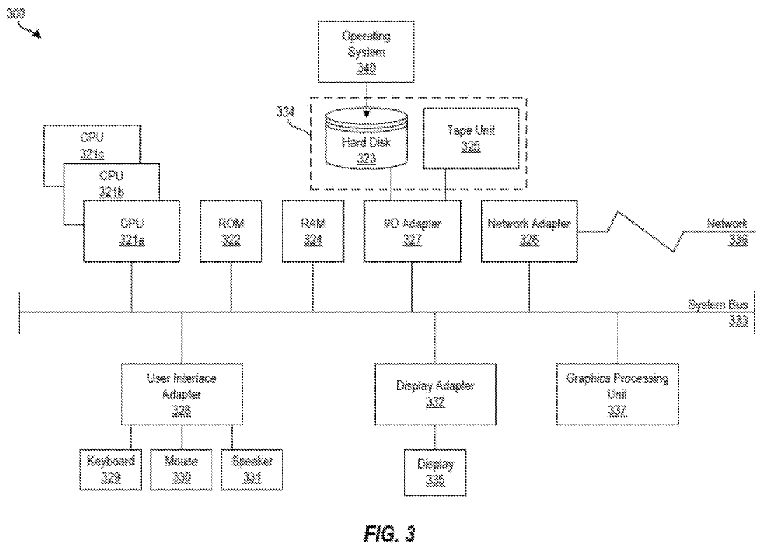

It is understood that the present disclosure is capable of being implemented in conjunction with any other type of computing environment now known or later developed. For example, FIG. 3 depicts a block diagram of a processing system 300 for implementing the techniques described herein. In examples, processing system 300 has one or more central processing units (processors) 321a, 321b, 321c, etc. (collectively or generically referred to as processor(s) 321 and/or as processing device(s)). In aspects of the present disclosure, each processor 321 can include a reduced instruction set computer (RISC) microprocessor. Processors 321 are coupled to system memory (e.g., random access memory (RAM) 324) and various other components via a system bus 333. Read only memory (ROM) 322 is coupled to system bus 333 and may include a basic input/output system (BIOS), which controls certain basic functions of processing system 300.

Further depicted are an input/output (I/O) adapter 327 and a network adapter 326 coupled to system bus 333. I/O adapter 327 may be a small computer system interface (SCSI) adapter that communicates with a hard disk 323 and/or a tape storage drive 325 or any other similar component. I/O adapter 327, hard disk 323, and tape storage device 325 are collectively referred to herein as mass storage 334. Operating system 340 for execution on processing system 300 may be stored in mass storage 334. The network adapter 326 interconnects system bus 333 with an outside network 336 enabling processing system 300 to communicate with other such systems.

A display (e.g., a display monitor) 335 is connected to system bus 333 by display adaptor 332, which may include a graphics adapter to improve the performance of graphics intensive applications and a video controller. In one aspect of the present disclosure, adapters 326, 327, and/or 232 may be connected to one or more I/O busses that are connected to system bus 333 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 333 via user interface adapter 328 and display adapter 332. A keyboard 329, mouse 330, and speaker 331 may be interconnected to system bus 333 via user interface adapter 328, which may include, for example, a Super I/O chip integrating multiple device adapters into a single integrated circuit.

In some aspects of the present disclosure, processing system 300 includes a graphics processing unit 337. Graphics processing unit 337 is a specialized electronic circuit designed to manipulate and alter memory to accelerate the creation of images in a frame buffer intended for output to a display. In general, graphics processing unit 337 is very efficient at manipulating computer graphics and image processing, and has a highly parallel structure that makes it more effective than general-purpose CPUs for algorithms where processing of large blocks of data is done in parallel.

Thus, as configured herein, processing system 300 includes processing capability in the form of processors 321, storage capability including system memory (e.g., RAM 324), and mass storage 334, input means such as keyboard 329 and mouse 330, and output capability including speaker 331 and display 335. In some aspects of the present disclosure, a portion of system memory (e.g., RAM 324) and mass storage 334 collectively store an operating system such as the AIX® operating system from IBM Corporation to coordinate the functions of the various components shown in processing system 300.

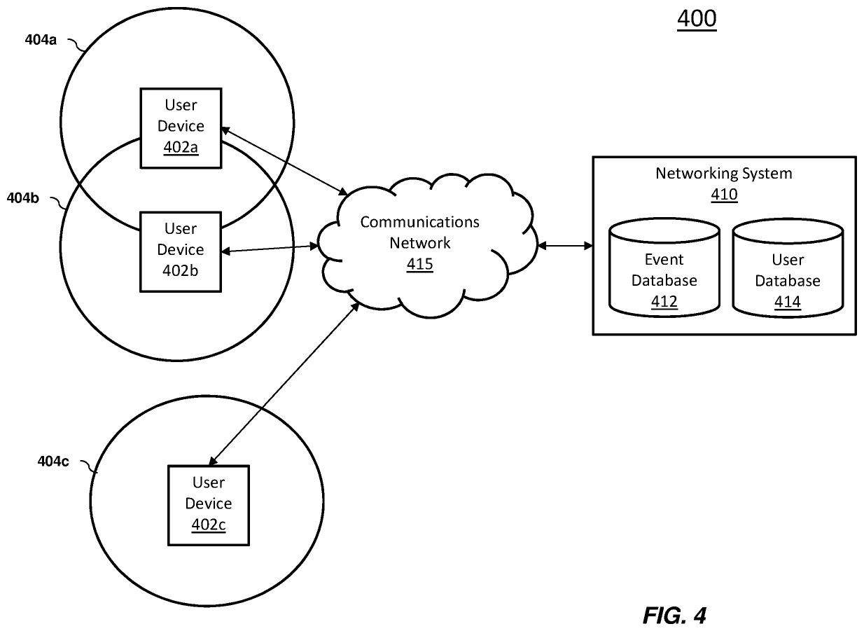

Turning now to a more detailed description of aspects of the present invention, FIG. 4 depicts a block diagram of a system 400 for facilitating proximity based connections at an event according to one or more embodiments described herein. The system 400 includes a networking system 410 that is configured to communicate with a plurality of user devices 402 via a communications network 415. The communications network can include one or more of a cellular communications network, a private network, a WiFi network, the Internet or the like. In exemplary embodiments, the user devices 402 are smartphones, smartwatches, or other portable electronic devices that are each associated with an individual. The user devices 402 are configured to communicate with the networking system 410 via the communications network 415 and are also configured to communicate directly with one or more other user devices 402 in close physical proximity. In exemplary embodiments, the user devices 402 can communicate directly with one another using a variety of known wireless communications protocols, such as near-field communications, Bluetooth, or the like. In exemplary embodiments, the user devices 402 are configured to estimate the distance themselves based on the signal strength of the wireless communications between the user devices 402.

In exemplary embodiments, the networking system 410 is configured to store information about each of the plurality of users and user devices 402 in the user database 414. The personal information can include, but is not limited to, a name of a user, a professional background of a user (e.g., current and former employers and titles), a personal background of a user (e.g., schools attended by the user, information regarding the users family and other interests), events the user is registered for, events the user has previously attended, one or more user devices 402 associated with the user and the like. In addition, the networking system 410 is configured to store information about events in an event database 412. The event information can include, but is not limited to, the location of an event, a date/time of the event, one or more registered attendees for the event and the like. In exemplary embodiments, the networking system 410 can be embodied in a processing system such as the one shown in FIG. 3 or in a cloud-based system such as the one shown in FIGS. 1 and 2.

In exemplary embodiments, individuals create profiles on the networking system 410 and use the networking system 410 to sign up or register for an event. In exemplary embodiments, when the individuals register for an event the user indicates one or more goals for the event. These goals are used by the networking system 410 to determine what other individuals at the event to connect the user with. These goals can be event specific goals or can be standing goals that apply to all events that the user is attending. For example, a user may be interested in meeting someone who works at a specific company while attending one event but may always be interested in meeting people that went to the same college as the user.

In exemplary embodiments, once a user registers for an event with the networking system 410 and the user device 402a associated with the individual determines that the user is attending the event, the user device 402a is configured to broadcast a unique code via low-power wireless communication. The user devices 402a, 402b, and 402c are configured to broadcast the unique code with a signal strength such that users with a predetermined range 404a, 404b, and 404c of the user devices 402a, 402b, and 402c can receive the unique code. In exemplary embodiments, the predetermined range can be set by a user of the user device 402. Once a user device 402a receives the unique code from another user device 402b at the event, the user device 402a can transmit the code to the networking system 410, which can determine if the user associated with the user device 402a should connect with the user of user device 402b. In another embodiment, the user device 402a could download information regarding other attendees at the event that would be of interest to the user and can perform a look-up of the user based on the unique code provided without transmitting the unique code to the networking system 410.

In exemplary embodiments, the user device 402a is configured to alert a user to connect with a user of a nearby user device 402b based on determining that the goals of the user of the user device 402a overlap with the information obtained for the user of the user device 402b. For example, if the user of a first user device has a goal of meeting people that live in the same city as he/she lives in and the user of user device 402b live is the same city, the user device 402a will alert the user to connect with the user of user device 402b. The alert can include a pop-up window being displayed by the user device 402a and can include an image, name, background information, and the like for the user of user device 402b.

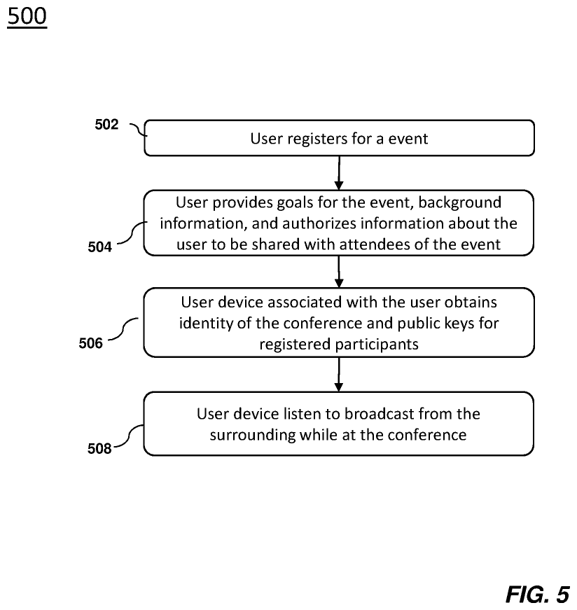

Referring now to FIG. 5, a flow diagram of a method 500 for facilitating proximity based connections at an event according to one or more embodiments described herein is shown. The method 500 can be performed using any suitable processing system or device, such as the processing system 300, networking system 410, and/or other suitable systems and/or devices. As shown at block 502, the method 500 includes a user registers for an event or pre-registration on the internet. In exemplary embodiments, registering for the event can include creating or updating a personal profile on the networking system. Next, as shown at block 504, the method 500 includes the user providing goals for the event, background information, and authorizes information about the user to be shared with attendees of the event. In exemplary embodiments, the user can select what information will be shared with the attendees of the event based on the type of the event and based on one or more characteristics of the attendees. For example, a user may opt to share some basic personal information, such as employer and job title, with all attendees of the event but may opt to share additional information only with attendees that the networking system suggests that the user connects with. Next, as shown at block 506, the method 500 includes a user device associated with the user obtaining an identity of the conference and a public key, or unique code, for one or more registered participants of the event. In exemplary embodiments, the user device obtains the public keys for each registered participant that the user of the user device should connect with at the event. The method 500 also includes the user device listening for broadcasts of a message and its cryptographic signature from other user devices while at the conference. This sender and its authenticity can be verified using the public key.

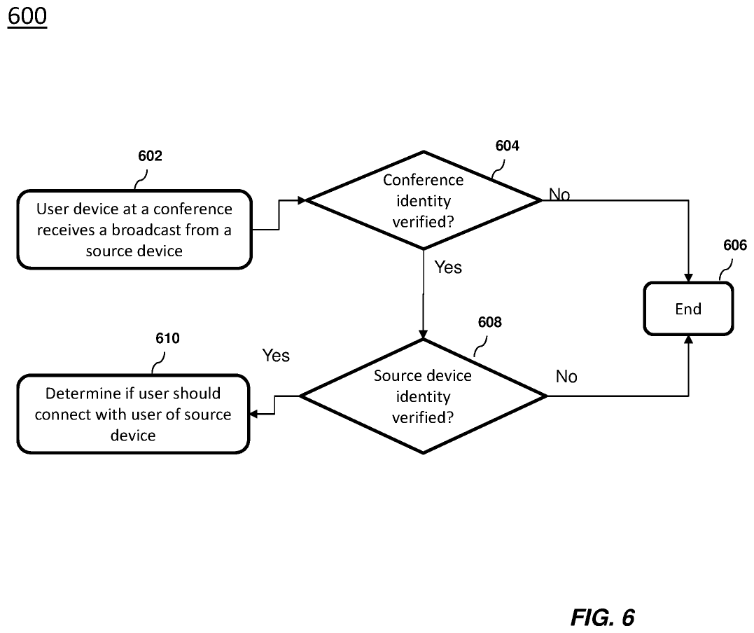

Referring now to FIG. 6, a flow diagram of a method 600 for facilitating proximity based connections at an event according to one or more embodiments described herein is shown. The method 600 can be performed using any suitable processing system or device, such as the processing system 300, networking system 410, and/or other suitable systems and/or devices. As shown at block 602, the method 600 includes a user device at a conference receiving a broadcast from a source device. The broadcast includes a message and its signature, or unique code, associated with the user of the source device. Next, as shown at decision block 604, the method 600 includes determining whether the conference identity of the source device can be verified. In exemplary embodiments, verifying the conference identity of the source device includes one or more of transmitting the message and its signature of the source device to a networking system, which will verify that the message and its signature corresponds to a user registered for the conference, or other cryptographic or security mechanism that uses information obtained through the registration system to verify the identity of the sender. If the conference identity of the source device cannot be verified, the method ends at block 606. Otherwise, as shown at decision block 608, the method 600 includes determining if the identity of the source device can be verified. In exemplary embodiments, verifying the identity of the source device includes determining that one or more pieces of information regarding the user device that transmitted the message and its signature match stored information associated with a user device of the user of the user. For example, when a user registers with the networking system the user provides the networking system with an international mobile equipment identity (IMEI) number or telephone number of their user device. In addition, when a user device at an event, it broadcasts the mobile number or IMEI and its signature. In order to verify the identity of a user device, the public key broadcast must be provided from a device that has the stored mobile number or IMEI. If the identity of the source device can be verified, the method 600 proceeds to block 610 and it is determined if the user should connect with the user of the source device.

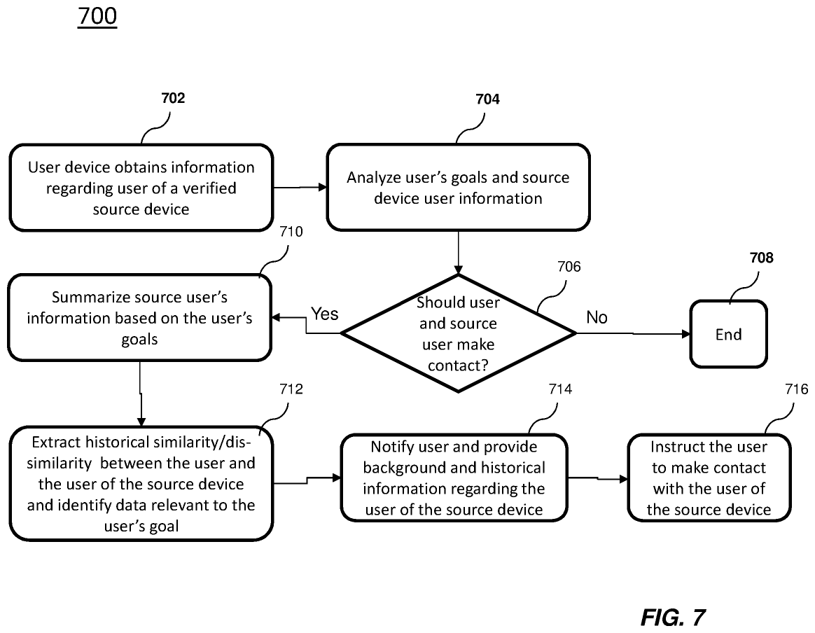

Referring now to FIG. 7, a flow diagram of a method 700 for facilitating proximity based connections at an event according to one or more embodiments described herein is shown. The method 700 can be performed using any suitable processing system or device, such as the processing system 300, networking system 410, and/or other suitable systems and/or devices. As shown at block 702, the method 700 includes the user device obtains information regarding the user of a verified source device. Next, as shown at block 704, the method 700 includes analyzing the goals of the user and the source device user information. The method 700 also includes determining if the user should make contact with the user of the source device, as shown at decision block 706. In exemplary embodiments, the determination of whether the user should make contact with the user of the source device is based on identifying an overlap between the goals of the user and the information of the user of the source device. If the user should make contact, the method proceeds to block 710 and includes summarizing the information of the user of the source device as it relates to the goals of the user. Otherwise, the method 700 proceeds to block 708 and ends.

Next, as shown at block 712, the method 700 includes extracting a historical similarity/dissimilarity between the user and the user of the source device and identify data relevant to the user's goal. The method 700 also includes notifying the user and providing background and historical information regarding the source user, as shown at block 714. Next, as shown at block 716, the method 700 includes instructing the user to make contact with the user of the source device.

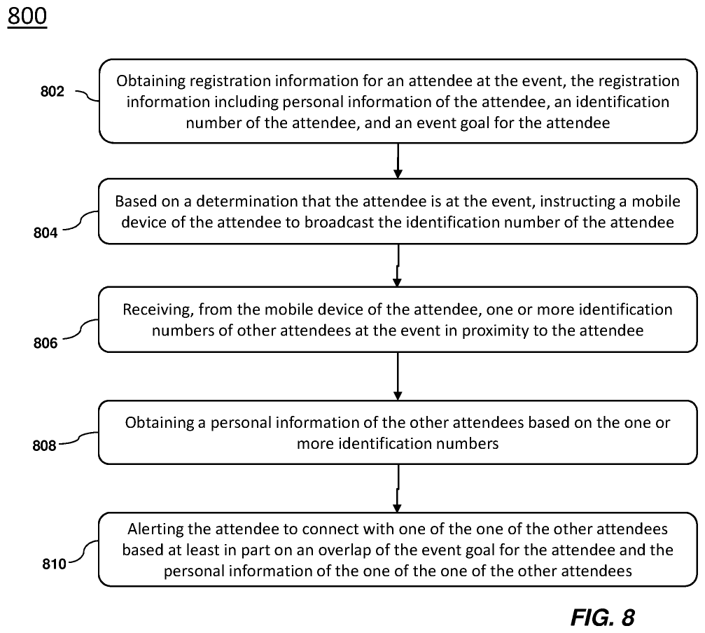

Referring now to FIG. 8, a flow diagram of a method 800 for facilitating proximity based connections at an event according to one or more embodiments described herein is shown. The method 800 can be performed using any suitable processing system or device, such as the processing system 300, networking system 410, and/or other suitable systems and/or devices. As shown at block 802, the method 800 includes obtaining registration information for an attendee at the event, the registration information including personal information of the attendee, an identification number of the attendee, and an event goal for the attendee. In exemplary embodiments, the event goal for the attendee includes an event-specific goal and one or more standing goals. Next, as shown at block 804, the method 800 includes instructing a mobile device of the attendee to broadcast the identification number of the attendee based on a determination that the attendee is at the event. The method 800 also includes receiving, from the mobile device of the attendee, one or more identification numbers of other attendees at the event in proximity to the attendee, as shown at block 806. In exemplary embodiments, the mobile device of the attendee receives the one or more identification numbers of other attendees at the event via near field communications.

Next, as shown at block 808, the method 800 includes obtaining personal information of the other attendees based on the one or more identification numbers. The method 800 also includes alerting the attendee to connect with one of the other attendees based at least in part on an overlap of the event goal for the attendee and the personal information of one of the one of the other attendees, as shown at block 810. In exemplary embodiments, alerting the attendee includes providing the attendee with a name, title, and image of one of the other attendees. In one embodiment, alerting the attendee further includes providing the attendee with a contact history between the attendee and one of the other attendees. In another embodiment, alerting the attendee further includes providing the attendee with an identification of common personal information between the attendee and one of the other attendees. In exemplary embodiments, the method also includes verifying an identity of the other attendees based on the one or more identification numbers and based upon device data obtained from mobile devices that provided the one or more identification numbers.

It should be understood that the process depicted in FIGS. 5, 6, 7 and 8 represent illustrations, and that other processes may be added or existing processes may be removed, modified, or rearranged without departing from the scope and spirit of the present disclosure. In one example, user departing from an airport can use the system to find other users with a similar goal, similar interest, going on the same plane, going to the same destination.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for facilitating proximity based connections at an event, the method comprising:
obtaining registration information for an attendee at the event, the registration information including personal information of the attendee, an identification number of the attendee, and an event goal for the attendee;
based on a determination that the attendee is at the event, instructing a mobile device of the attendee to broadcast the identification number of the attendee;
receiving, from the mobile device of the attendee, one or more identification numbers of other attendees at the event in proximity to the attendee;
obtaining personal information of the other attendees based on the one or more identification numbers; and
alerting the attendee to connect with one of the one of the other attendees based at least in part on an overlap of the event goal for the attendee and the personal information of the one of the other attendees.

2. The method of claim 1, wherein alerting the attendee includes providing the attendee with a name, title and image of the one of the other attendees.

3. The method of claim 1, wherein alerting the attendee further includes providing the attendee with a contact history between the attendee and the one of the other attendees.

4. The method of claim 1, wherein alerting the attendee further includes providing the attendee with an identification of common personal information between the attendee and the one of the other attendees.

5. The method of claim 1, wherein the event goal for the attendee includes an event-specific goal and one or more standing goals.

6. The method of claim 1, wherein the mobile device of the attendee receives the one or more identification numbers of other attendees at the event via near field communications.

7. The method of claim 1, further comprising verifying an identity of the other attendees based on the one or more identification numbers and based upon device data obtained from mobile devices that provided the one or more identification numbers.

8. A system comprising:
a memory comprising computer readable instructions; and
a processing device for executing the computer readable instructions for performing a method comprising:
obtaining registration information for an attendee at an event, the registration information including personal information of the attendee, an identification number of the attendee, and an event goal for the attendee;
based on a determination that the attendee is at the event, instructing a mobile device of the attendee to broadcast the identification number of the attendee;
receiving, from the mobile device of the attendee, one or more identification numbers of other attendees at the event in proximity to the attendee;
obtaining personal information of the other attendees based on the one or more identification numbers; and
alerting the attendee to connect with one of the one of the other attendees based at least in part on an overlap of the event goal for the attendee and the personal information of the one of the other attendees.

9. The system of claim 8, wherein alerting the attendee includes providing the attendee with a name, title and image of the one of the other attendees.

10. The system of claim 8, wherein alerting the attendee further includes providing the attendee with a contact history between the attendee and the one of the other attendees.

11. The system of claim 8, wherein alerting the attendee further includes providing the attendee with an identification of common personal information between the attendee and the one of the other attendees.

12. The system of claim 8, wherein the event goal for the attendee includes an event-specific goal and one or more standing goals.

13. The system of claim 8, wherein the mobile device of the attendee receives the one or more identification numbers of other attendees at the event via near field communications.

14. The system of claim 8, further comprising verifying an identity of the other attendees based on the one or more identification numbers and based upon device data obtained from mobile devices that provided the one or more identification numbers.

15. A computer program product comprising:
a computer readable storage medium having program instructions embodied therewith, the program instructions executable by a processing device to cause the processing device to perform a method for enhanced teleconferencing, the method comprising:
obtaining registration information for an attendee at an event, the registration information including personal information of the attendee, an identification number of the attendee, and an event goal for the attendee;
based on a determination that the attendee is at the event, instructing a mobile device of the attendee to broadcast the identification number of the attendee;
receiving, from the mobile device of the attendee, one or more identification numbers of other attendees at the event in proximity to the attendee;
obtaining personal information of the other attendees based on the one or more identification numbers; and
alerting the attendee to connect with one of the one of the other attendees based at least in part on an overlap of the event goal for the attendee and the personal information of the one of the other attendees.

16. The computer program product of claim 15, wherein alerting the attendee includes providing the attendee with a name, title and image of the one of the other attendees.

17. The computer program product of claim 15, wherein alerting the attendee further includes providing the attendee with a contact history between the attendee and the one of the other attendees.

18. The computer program product of claim 15, wherein alerting the attendee further includes providing the attendee with an identification of common personal information between the attendee and the one of the other attendees.

19. The computer program product of claim 15, wherein the event goal for the attendee includes an event-specific goal and one or more standing goals.

20. The computer program product of claim 15, wherein the mobile device of the attendee receives the one or more identification numbers of other attendees at the event via near field communications.
